(19) United States
(12) Patent Application Publication
(10) Pub. No.: US 2013/0045825 A1
(43) Pub. Date: Feb. 21, 2013

(54) FOLDABLE LEG REST

(71) Applicants: Qing-Kun Yin, Zhuhai (CN); Chin-Chen Chang, Taipei City (TW)

(72) Inventors: Qing-Kun Yin, Zhuhai (CN); Chin-Chen Chang, Taipei City (TW)

(73) Assignee: Wan-Yu Li, Taipei City (TW)

(21) Appl. No.: 13/493,607

(22) Filed: Jun. 11, 2012

(30) Foreign Application Priority Data
Aug. 17, 2011 (CN) 201120298478.9

(51) Int. Cl. A47C 20/04; F16H 37/02; F16H 1/16

(52) U.S. Cl. 474/150; 74/89; 74/89.14

(57) ABSTRACT

A foldable leg rest has a base, a first folding assembly and a second folding assembly. The base has a mounting board and a first stage drive mechanism mounted on the mounting board. The first folding assembly is pivotally connected to the base and has a first frame and a second stage drive mechanism mounted in the first frame. The second folding assembly is pivotally connected to the first folding assembly. In use, the first stage drive mechanism is operated to drive the first folding assembly to pivot relative to the base and the second stage drive mechanism is operated to drive the second folding assembly to pivot relative to the first folding assembly. Therefore, the legs of a sitter can be stretched and placed on the folding assemblies so as to enhance comfort and minimize fatigue.

### BACKGROUND OF THE INVENTION

1. Field of the Invention

The present invention relates to a leg rest, and more particularly to a foldable leg rest mounted on a front end of a chair for supporting the legs of a sitter in a stretched condition.

2. Description of the Prior Arts

Chairs allow people to sit thereon and support weights of sitters. A conventional chair substantially comprises a seat and a backrest for supporting the back of a sitter. The backrest may be adjustable in angle relative to the seat by an angle adjuster to fit different needs of different sitters.

However, when a person sits on the chair for a long time, for example on a long vehicle trip, the legs of the sitter on the conventional chair will become tired, numb or pained due to long time of bending. Accordingly, the conventional chair should be further improved to provide an enhanced comfort for the sitter.

To overcome the shortcomings, the present invention provides a foldable leg rest to mitigate or obviate the aforementioned problems.

### SUMMARY OF THE INVENTION

The main object of the present invention is to provide a foldable leg rest that supports the legs of a sitter in a stretched condition.

To achieve the foregoing objective, the foldable leg rest in accordance with the present invention comprises a base, a first folding assembly and a second folding assembly. The base includes a mounting board and a first stage drive mechanism mounted on the mounting board. The first folding assembly is pivotally connected to the base and includes a first frame and a second stage drive mechanism. The first frame has a rear end pivotally connected to the base. The second stage drive mechanism is mounted in the first frame. The second folding assembly is pivotally connected to the first folding assembly and includes a second frame. The second frame has a rear end pivotally connected to a front end of the first frame. In use, the first stage drive mechanism is operated to drive the first folding assembly to pivot relative to the base, the second stage drive mechanism is operated to drive the second folding assembly to pivot relative to the first folding assembly and the second folding assembly can be folded toward a bottom surface of the first folding assembly. Therefore, the legs of a sitter can be stretched and placed on the folding assemblies so as to enhance comfort and minimize fatigue.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a foldable leg rest in accordance with the present invention shown in a folded state;

FIG. 2 is a top perspective view of the foldable leg rest in FIG. 1 shown in an unfolded state;

FIG. 3 is a bottom perspective view of the foldable leg rest in FIG. 1 shown in an unfolded state;

FIG. 4 is an enlarged perspective view of a base of the foldable leg rest in FIG. 1;

FIG. 5 is a partially enlarged perspective view of the base of the foldable leg rest in FIG. 1;

FIGS. 6 to 8 are partially enlarged perspective views of a second stage drive mechanism of the foldable leg rest in FIG. 1;

FIG. 9 is an enlarged perspective view of a third stage drive mechanism and a footrest of the foldable leg rest in FIG. 1;

FIG. 10 is a partially enlarged exploded perspective view of the third stage drive mechanism of the foldable leg rest in FIG. 1;

FIG. 11 is an enlarged perspective view of a driving shaft and a supporting rod of the foldable leg rest in FIG. 1;

FIG. 12 is a side view of the foldable leg rest in FIG. 1 shown in a folded state;

FIG. 13 is an operational side view of the foldable leg rest in FIG. 1 showing that a second folding assembly is unfolded relative to a first folding assembly; and

FIG. 14 is a side view of the foldable leg rest in FIG. 1 shown in an unfolded state.

### DETAILED DESCRIPTION OF THE PREFERRED EMBODIMENTS

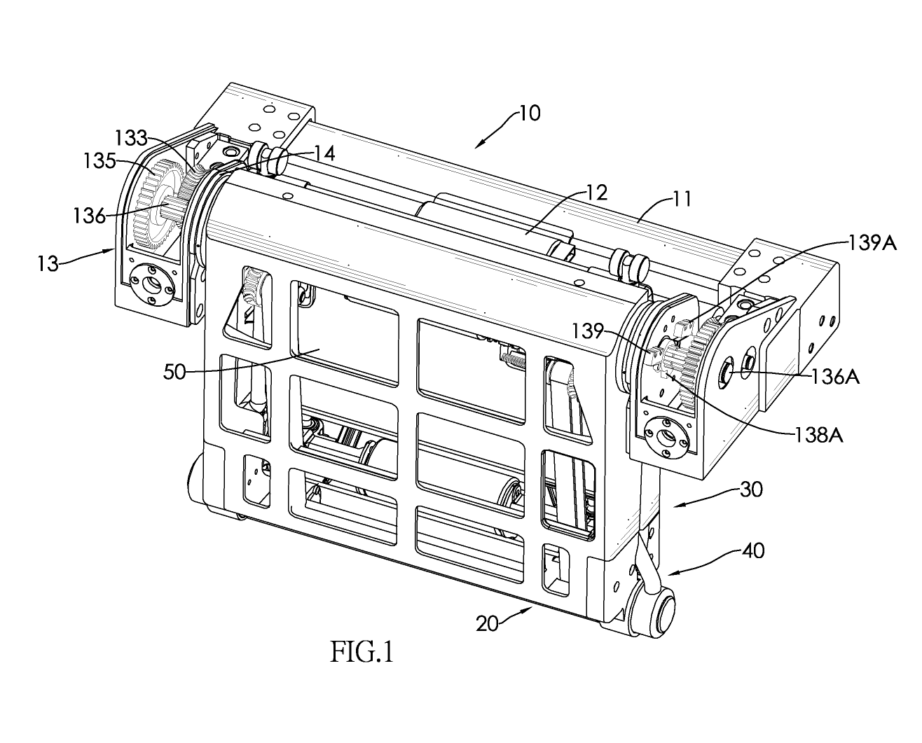

With reference to FIGS. 1 to 3, a foldable leg rest in accordance with the present invention comprises a base 10, a first folding assembly 20, a second folding assembly 30, a support stand 40 and a footrest 50.

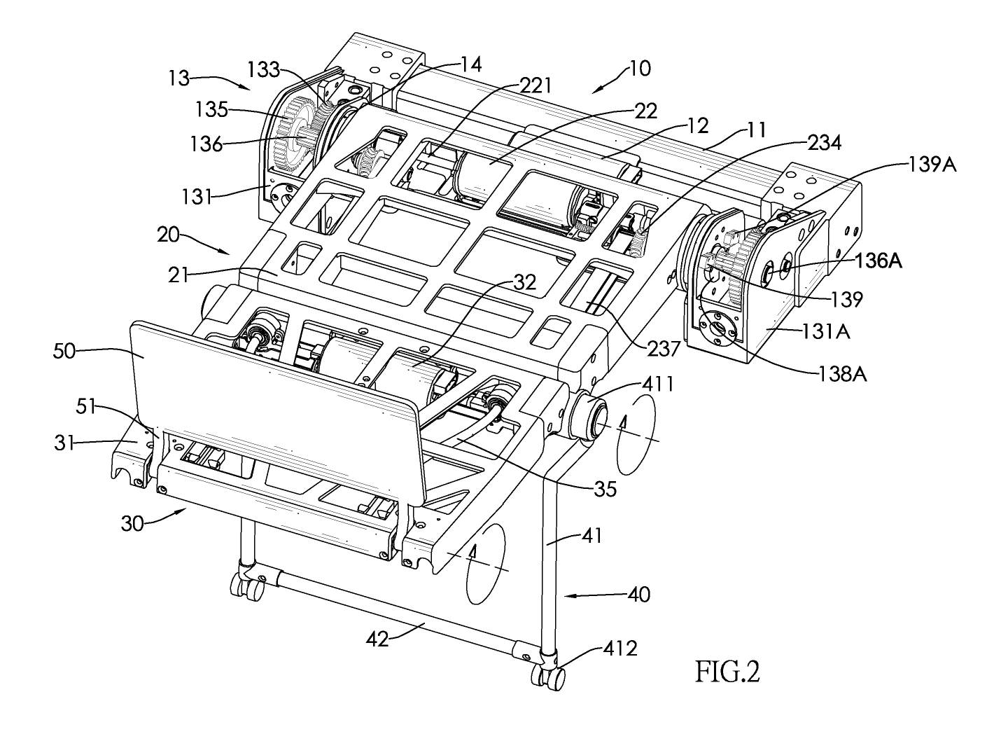

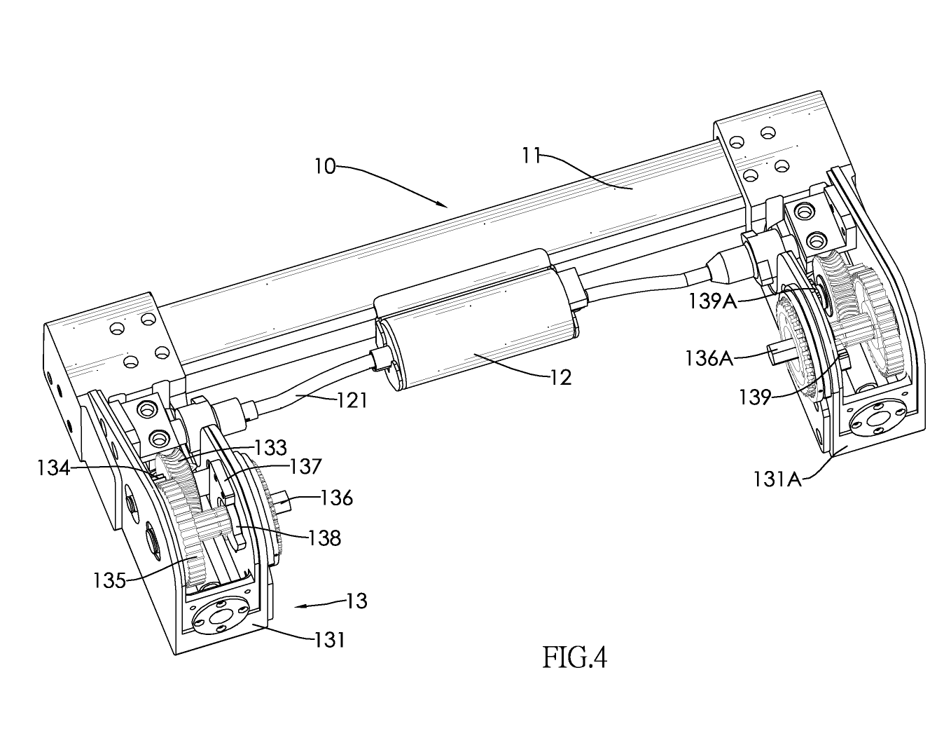

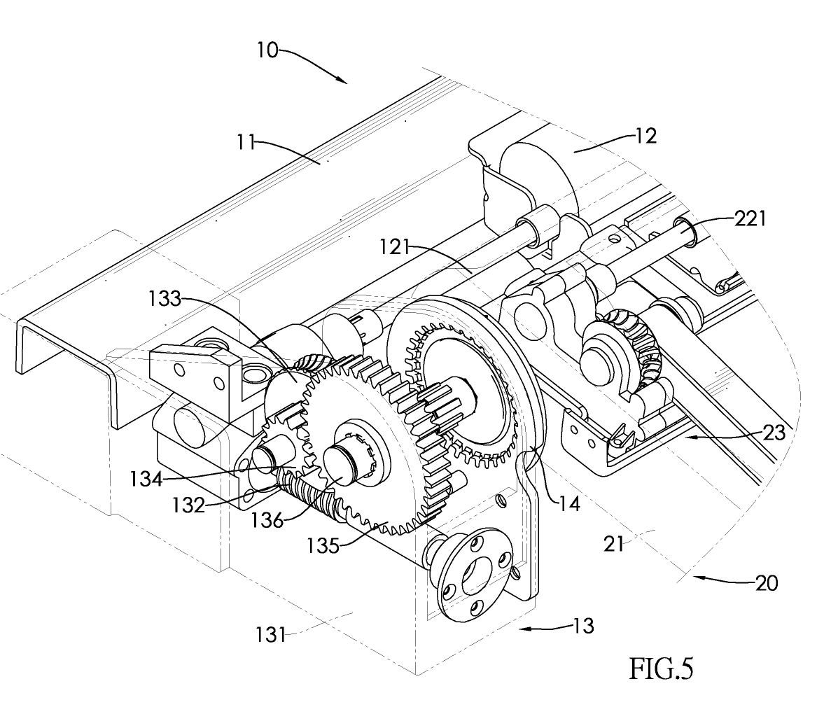

The base 10 is mounted on a front end of a seat and includes a mounting board 11 and a first stage drive mechanism. The first stage drive mechanism is mounted on the mounting board 11 and has a first stage direct current (DC) motor 12, two gearings 13 and two first stage angle adjusters 14. The first stage DC motor 12 is secured to a middle portion of the mounting board 11 and has two ends and two flexible shafts 121. The flexible shafts 121 are respectively connected to the ends of the first stage DC motor 12. With reference to FIGS. 4 and 5, the gearings 13 are respectively disposed at two sides of the mounting board 11. Each gearing 13 has a mounting bracket 131 secured to the mounting board 11 and receiving a first stage worm 132, a first stage worm gear 133, a small gear 134, a large gear 135 and a pivotal shaft 136. The first stage worm 132 is driven by a corresponding flexible shaft 121 of the first stage DC motor 12. The first stage worm gear 133 engages the first stage worm 132. The small gear 134 is coaxially mounted on the first stage worm gear 133. The large gear 135 engages the small gear 134. The pivotal shaft 136 is coaxially mounted on the large gear 135. A limiting block 137 is secured to a sidewall of one mounting bracket 131. A first abutting block 138 is secured around one pivotal shaft 136 and is able to abut a top or a bottom of the limiting block 137. With further reference to FIG. 2, two first stage contact switches 139,139A are respectively secured to a sidewall of the other mounting bracket 131A. A second abutting block 138A is secured around the other pivotal shaft 136A and is contactable with one of the first stage contact switches 139,139A.

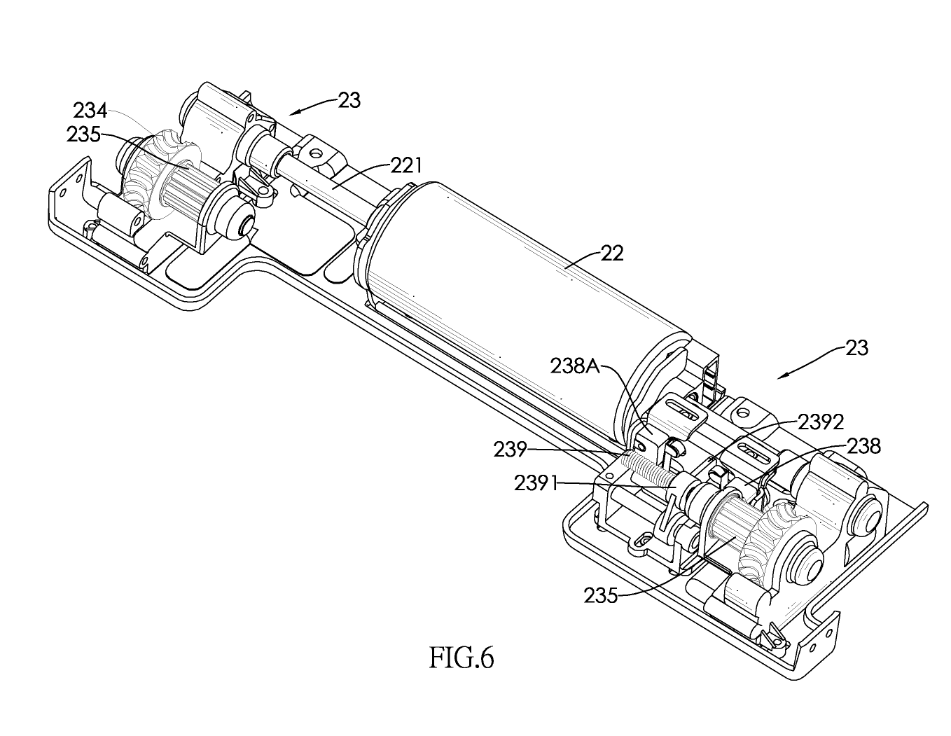

With reference to FIGS. 2 and 5, the first folding assembly 20 is pivotally connected to the base 10 and includes a first frame 21 and a second stage drive mechanism. The first frame 21 has a front end and a rear end. The rear end of the first frame 21 is pivotally connected between the two gearings 13. Each first stage angle adjuster 14 is mounted between one side of the rear end of the first frame 21 and a corresponding mounting bracket 131 and is driven by a corresponding pivotal shaft 136 to allow the first folding assembly 20 to be stably pivoted relative to the base 10. The angle adjuster 14 is conventional and thus a detailed description thereof will be omitted. With further reference to FIG. 6, the second stage drive mechanism is mounted in the first frame 21 and has a second stage DC motor 22, two worm drives 23 and two second stage angle adjusters 24. The second stage DC motor 22 is secured to a middle portion of the rear end of the first frame 21 and has two ends and two flexible shafts 221. The flexible shafts 221 are respectively connected to the ends of the second stage DC motor 22. The worm drives 23 are respectively disposed at two sides of the first frame 21.

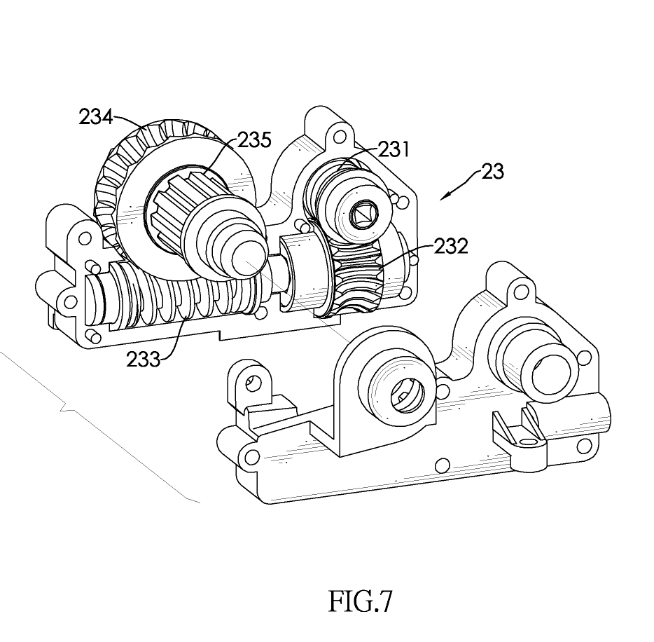

With reference to FIGS. 6 to 8, each worm drive 23 has a second stage first worm 231, a second stage first worm gear 232, a second stage second worm 233, a second stage second worm gear 234, a driving pulley 235, a driven pulley 236, a belt 237 and a driving shaft 25. The second stage first worm 231 is connected to a corresponding flexible shaft 221 of the second stage DC motor 22 so that the second stage DC motor 22 can drive the second stage first worm 231 to rotate. The second stage first worm gear 232 engages the second stage first worm 231. The second stage second worm 233 is coaxially mounted on the second stage first worm gear 232. The second stage second worm gear 234 engages the second stage second worm 233. The driving pulley 235 is coaxially mounted on the second stage second worm gear 234. The driven pulley 236 is rotatably mounted on the front end of the first frame 21. The belt 237 is mounted around the driving pulley 235 and the driven pulley 236. The driving shaft 25 is coaxially mounted on the driven pulley 236. Two second stage contact switches 238,238A are respectively mounted at the rear end of the first frame 21 and are disposed at one side adjacent to one of the worm drives 23. A threaded rod 239 is coaxially mounted on the driving pulley 235 adjacent to the second stage contact switches 238,238A. A nut 2391 is screwed onto the threaded rod 239 and is longitudinally movable thereon. The nut 2391 has a contacting segment 2392 extending therefrom and being contactable with one of the second stage contact switches 238,238A.

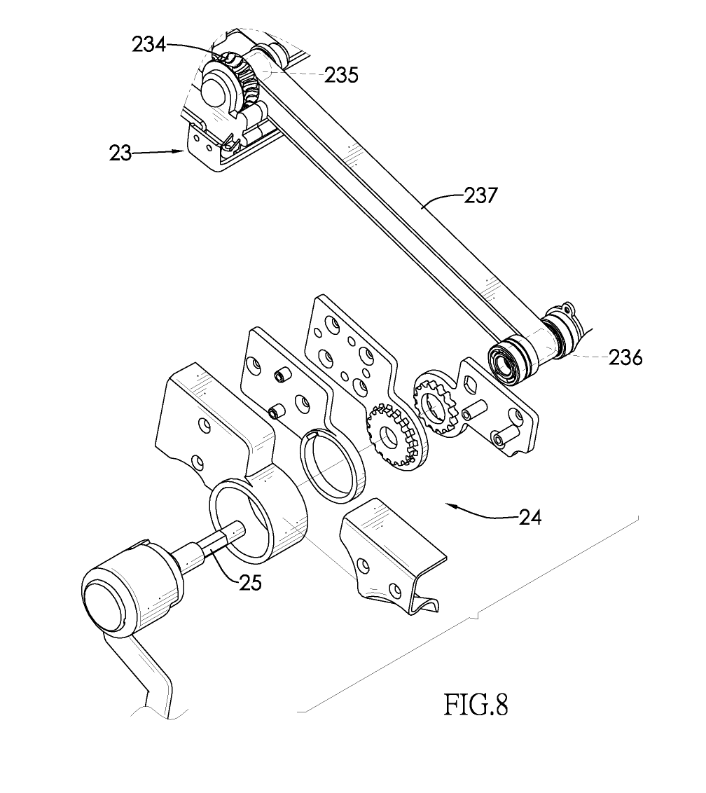

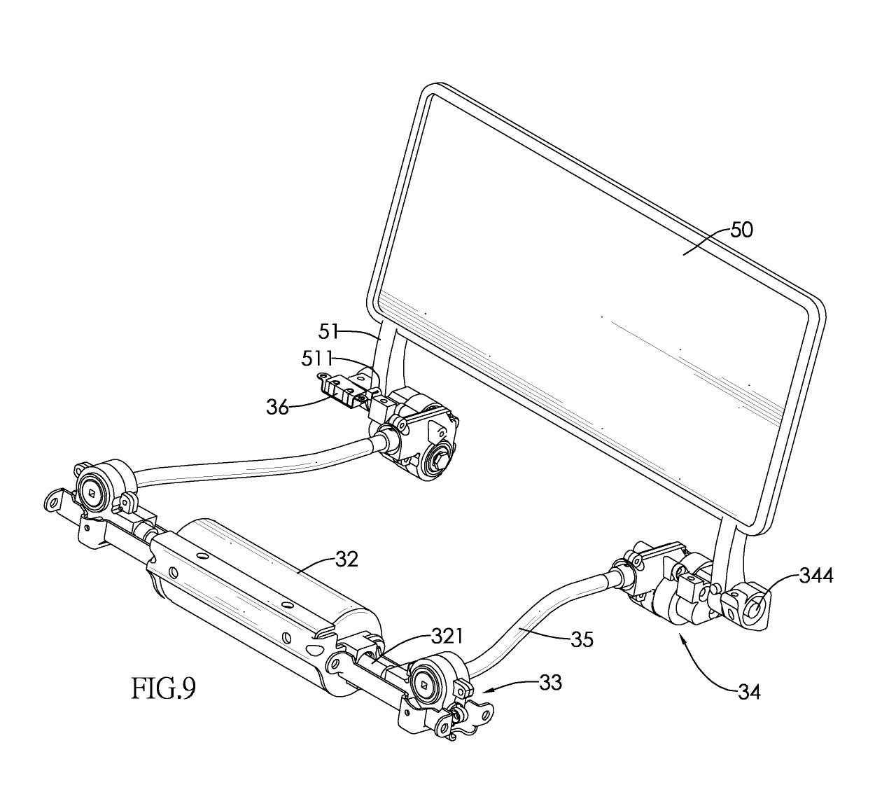

With reference to FIGS. 2 and 8, the second folding assembly 30 is pivotally connected to the first folding assembly 20 and includes a second frame 31 and a third stage drive mechanism. The second frame 31 has a front end and a rear end. The rear end of the second frame 31 is pivotally connected to the front end of the first frame 21. Each second stage angle adjuster 24 is mounted between one side of the rear end of the second frame 31 and a corresponding side of the front end of the first frame 21, and is driven by a corresponding driving shaft 25 to allow the second folding assembly 30 to be stably pivoted relative to the first folding assembly 20 and to be foldable toward a bottom surface of the first folding assembly 20. With further reference to FIG. 9, the third stage drive mechanism is mounted in the second frame 31 and has a third stage DC motor 32, two rear worm drives 33 and two front worm drives 34. The third stage DC motor 32 is secured to a middle portion of the rear end of the second frame 31 and has two ends and two flexible shafts 321. The flexible shafts 321 are respectively connected to the ends of the third stage DC motor 32. The rear worm drives 33 are respectively disposed at two sides of the rear end of the second frame 31. The front worm drives 34 are respectively disposed at two sides of the front end of the second frame 31.

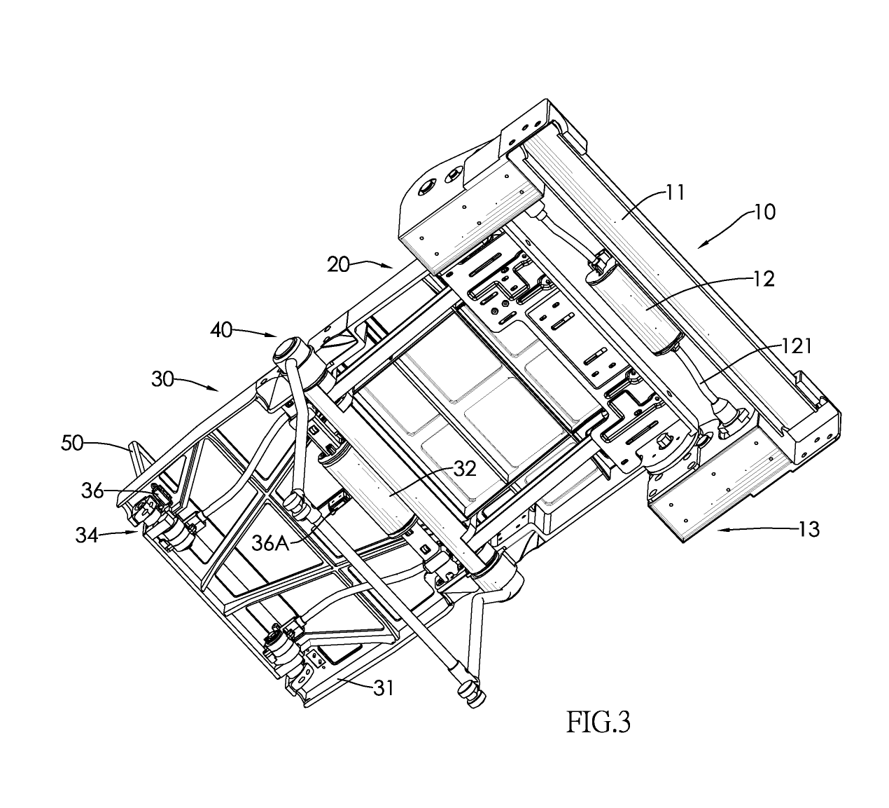

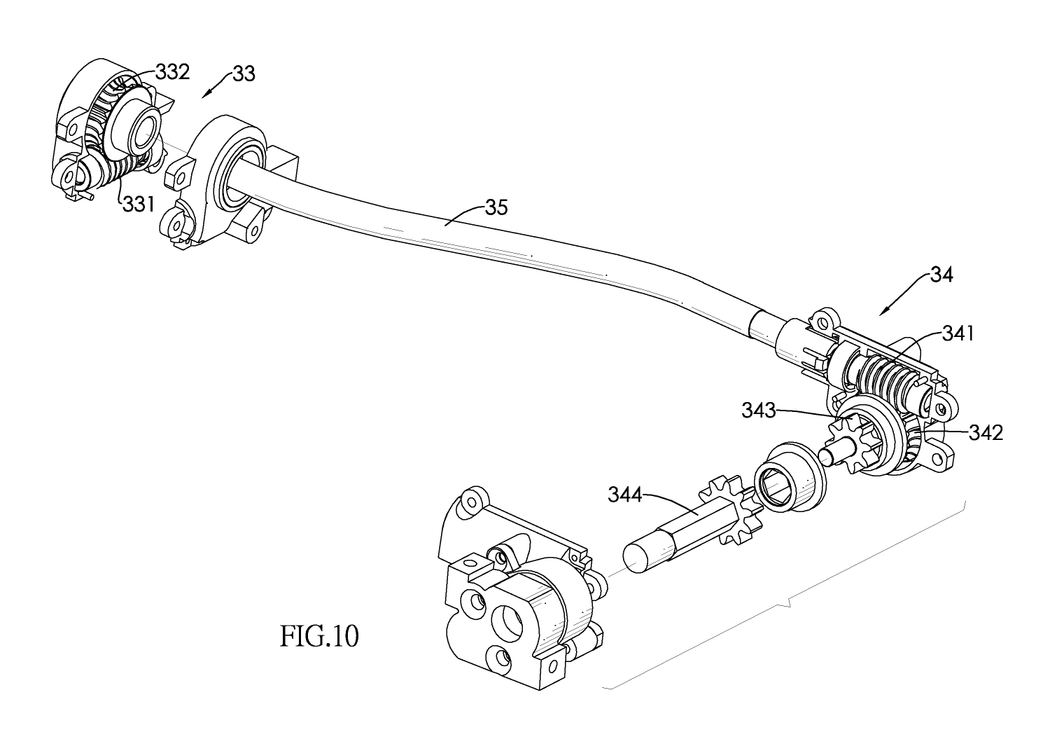

With further reference to FIG. 10, each rear worm drive 33 has a third stage rear worm 331 and a third stage rear worm gear 332. The third stage rear worm 331 is connected to a corresponding flexible shaft 321 of the third stage DC motor 32 so that the third stage DC motor 32 can drive the third stage rear worm 331 to rotate. The third stage rear worm gear 332 engages the third stage rear worm 331 and is connected to one of two ends of a third stage flexible shaft 35. Each front worm drive 34 has a third stage front worm 341, a third stage front worm gear 342, a third stage gear 343 and a driving rod 344. The third stage front worm 341 is connected to the other end of the third stage flexible shaft 35. The third stage front worm gear 342 engages the third stage front worm 341. The third stage gear 343 is coaxially mounted on the third stage front worm gear 342. The driving rod 344 has an end and a gear formed on the end and engaging the third stage gear 343. With reference to FIG. 3, a third stage front contact switch 36 is mounted on a bottom surface of the second frame 31 adjacent to one of the front worm drives 34. A third stage rear contact switch 36A is mounted on the bottom surface of the second frame 31 adjacent to the third stage DC motor 32.

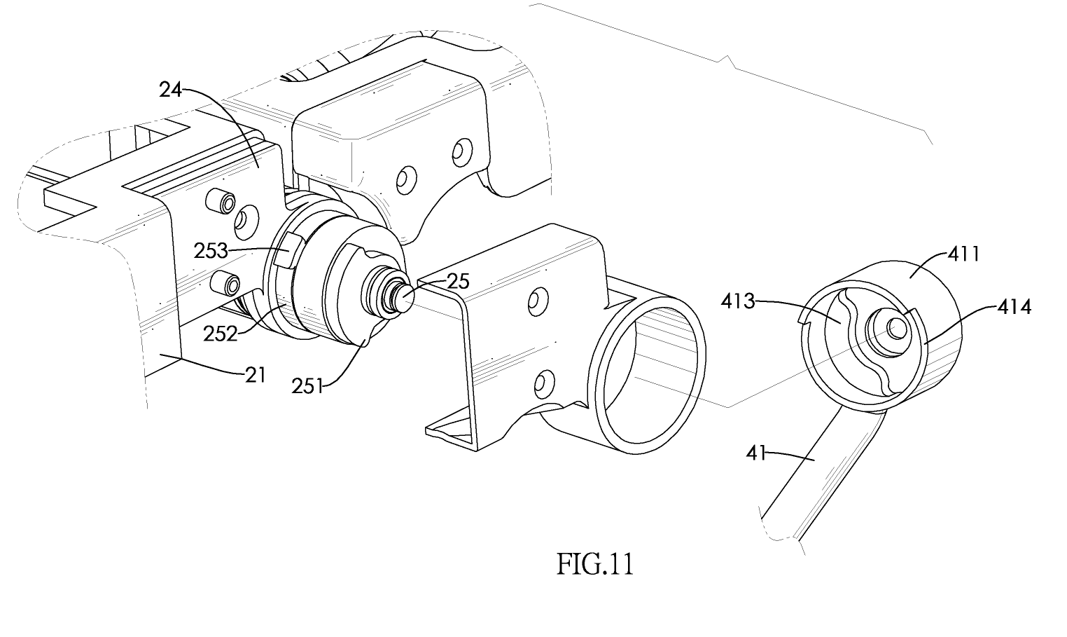

With reference to FIG. 2,the support stand 40 is pivotally connected between the first folding assembly 20 and the second folding assembly 30 and includes two supporting rods 41 and a connecting rod 42. Each supporting rod 41 has a top end, a bottom end, a cover 411 and a roller 412. The cover 411 is formed on the top end of the supporting rod 41. The roller 412 is rotatably mounted on the bottom end of the supporting rod 41. The connecting rod 42 connects the two supporting rods 41 between adjacent bottom ends of the supporting rods 41. With reference to FIG. 11, the cover 411 is pivotally connected to a corresponding connecting part of the first frame 21 and the second frame 31, covers a corresponding driving shaft 25 and has an internal surface, an open end surface, a pushed block 413 and a recess 414. The pushed block 413 protrudes from the internal surface of the cover 411. The recess 414 is formed in the open end surface of the cover 411 and has two recess side surfaces. The driving shaft 25 has an end, a pushing block 251 and a ring 252. The pushing block 251 is secured around the driving shaft 25 near the end, is driven by the driving shaft 25 and is able to abut the pushed block 413 of a corresponding cover 411. The ring 252 is mounted around the driving shaft 25 and has an outer surface and a projection 253. The ring 252 is not driven by the driving shaft 25 because a bearing is mounted between the driving shaft 25 and ring 252. The projection 253 protrudes from the outer surface of the ring 252 and is able to abut one recess side surface of the recess 414 of the corresponding cover 411.

With reference to FIGS. 2 and 9,the footrest 50 is pivotally connected to the second folding assembly 30 and includes two sides and two pivotal ears 51. The pivotal ears 51 are formed respectively on the sides of the footrest 50 and are respectively secured to the driving rods 344 disposed at the front end of the second frame 31. The driving rods 344 can drive the footrest 50 to pivot relative to the second folding assembly 30 and to be foldable toward a bottom surface of the second folding assembly 30 to contact the third stage rear contact switch 36A. One of the pivotal ears 51 has a contacting block 511extending therefrom and being contactable with the third stage front contact switch 36.

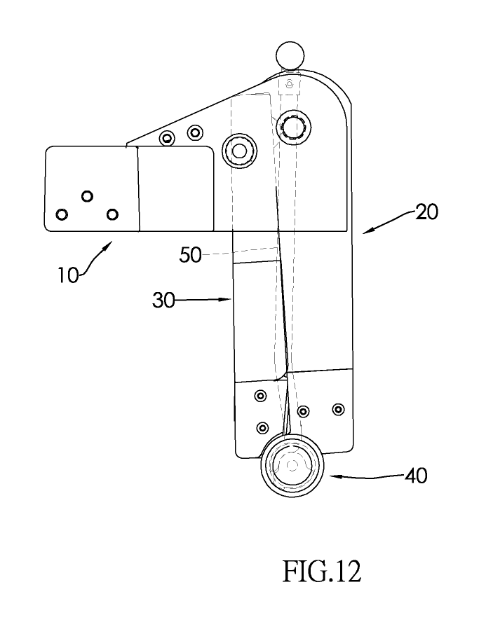

To unfold the leg rest in accordance with the present invention, with reference to FIGS. 1, 5 and 12, the first stage DC motor 12 is switched on and drives the first stage worms 132 to rotate, and the first stage angle adjusters 14 can be driven to make the first folding assembly 20 pivoted relative to the base 10 with the transmission of the first stage worm gears 133, the small gears 134, the large gears 135 and the pivotal shafts 136. With further reference to FIGS. 2 and 4, when the first folding assembly 20 is being pivoted relative to the base 10, one pivotal shaft 136 drives the first abutting block 138 and the other pivotal shaft 136A drives the second abutting block 138A. As the first folding assembly 20 is pivoted forward 90 degrees relative to the base 10, the first abutting block 138 will abut the top of the limiting block 137 and the second abutting block 138A will contact one first stage contact switch 139. An electric circuit connected to the first stage contact switch 139 can be detected to determine if the electric circuit is a loop circuit and to see if the first folding assembly 20 completes 90 degrees of pivoting.

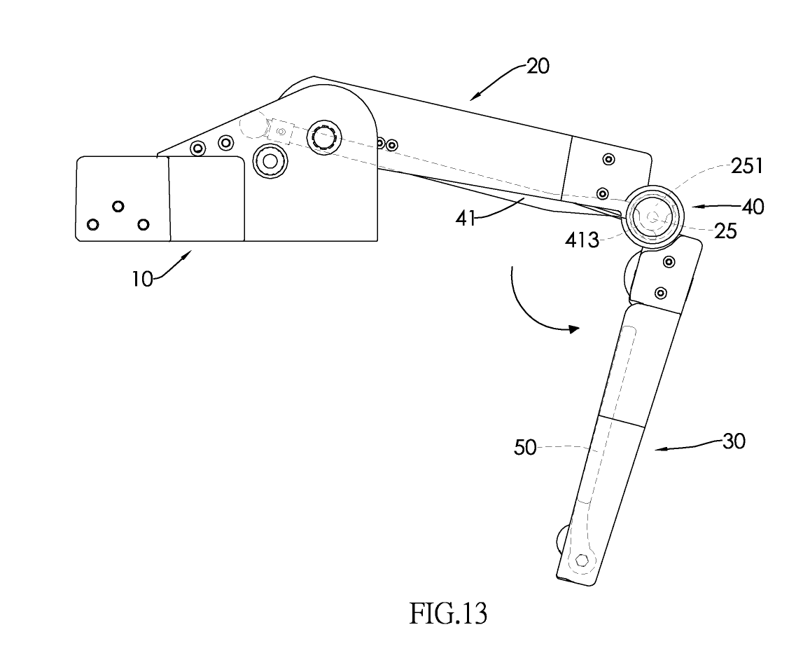

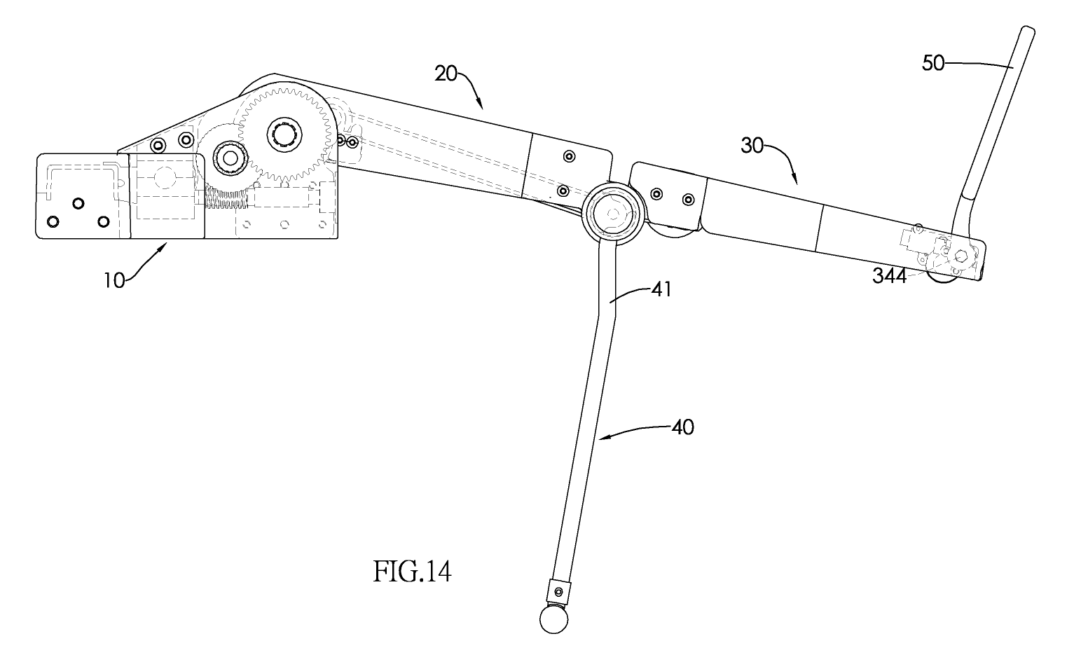

With reference to FIGS. 6 to 8, the second stage DC motor 22 is switched on and drives the second stage first worms 231 to rotate, and the second stage angle adjusters 24 can be driven to make the second folding assembly 30 pivoted relative to the first folding assembly 20 with the transmission of the second stage first worm gears 232, the second stage second worms 233, the second stage second worm gears 234, the driving pulleys 235, the belts 237, the driven pulleys 236 and the driving shafts 25. With reference to FIGS. 11 and 13, when the second folding assembly 30 is being pivoted forward between 0 and 90 degrees relative to the first folding assembly 20, the pushing blocks 251 secured to the driving shafts 25 do not abut the pushed blocks 413 of the supporting rods 41. As the second folding assembly 30 is pivoted forward between 90 and 180 degrees relative to the first folding assembly 20, the pushing blocks 251 will abut and push the pushed blocks 413 of the supporting rods 41 to drive the support stand 40 to pivot forward relative to the first folding assembly 20. With reference to FIG. 6,when the second folding assembly 30 is being pivoted relative to the first folding assembly 20, the threaded rod 239 secured to the driving pulley 235 drives the nut 2391 to move longitudinally. With further reference to FIG. 14, as the second folding assembly 30 is pivoted forward 180 degrees relative to the first folding assembly 20 and the support stand 40 is pivoted forward 90 degrees relative to the first folding assembly 20, the contacting segment 2392 of the nut 2391 will contact one second stage contact switch 238. An electric circuit connected to the second stage contact switch 238 can be detected to determine if the electric circuit is a loop circuit and to see if the second folding assembly 30 completes 180 degrees of pivoting. Besides, when the second folding assembly 30 completes its pivoting movement, one recess side surface of the recesses 414 of the supporting rods 41 abut the projections 253 of the rings 252 of the driving shafts 25.

With reference to FIGS. 9, 10 and 14, the third stage DC motor 32 is switched on and drives the third stage rear worms 331 to rotate, and the footrest 50 can be pivoted relative to the second folding assembly 30 with the transmission of the third stage rear worm gears 332, the third stage flexible shafts 35, the third stage front worms 341, the third stage front worm gears 342, the third stage gears 343 and the driving rods 344. The footrest 50 can be pivoted relative to the second folding assembly 30 until the contacting block 511 of the pivotal ear 51 contacts the third stage front contact switch 36. An electric circuit connected to the third stage front contact switch 36 can be detected to determine if the electric circuit is a loop circuit and to see if the footrest 50 completes its pivoting movement.

The leg rest in accordance with the present invention includes a three stage folding structure to extend its length. Therefore, the legs of a sitter can be stretched and placed on the folding assemblies 20,30 and feet of the sitter can step onto the footrest 50. In addition, sponge pads can be attached to top surfaces of the folding assemblies 20,30 to enhance comfort. Moreover, the support stand 40 standing on a mounting surface can reinforce the leg rest and prevent deformation.

To fold the leg rest in accordance with the present invention, with reference to FIG. 3, the third stage DC motor 32 is switched on and drives the footrest 50 to pivot toward the bottom surface of the second folding assembly 30. When the footrest 50 is adjacent to the bottom surface of the second folding assembly 30 and contacts the third stage rear contact switch 36A, the footrest 50 completes its folding movement. With reference to FIGS. 6 and 11, the second stage DC motor 22 is switched on and drives the second folding assembly 30 to pivot toward the bottom surface of the first folding assembly 20. As the second folding assembly 30 is being pivoted rearward between 0 and 90 degrees relative to the first folding assembly 20, the pushing blocks 251 secured to the driving shafts 25 do not abut the pushed blocks 413 of the supporting rods 41. As the second folding assembly 30 is pivoted rearward between 90 and 180 degrees relative to the first folding assembly 20, the pushing blocks 251 of the driving shafts 25 will abut and push the pushed blocks 413 of the supporting rods 41 to drive the support stand 40 to pivot rearward relative to the first folding assembly 20. When the threaded rod 239 secured to the driving pulley 235 drives the contacting segment 2392 of the nut 2391 to contact the other second stage contact switch 238A, the second folding assembly 30 and the support stand 40 complete their folding movement. With reference to FIGS. 1 and 4, the first stage DC motor 12 is switched on and drives the first folding assembly 20 to pivot rearward. When one pivotal shaft 136 drives the first abutting block 138 to abut the bottom of the limiting block 137 and the other pivotal shaft 136A drives the second abutting block 138A to contact the other first stage contact switch 139A, the first folding assembly 20 completes its folding movement. Therefore, an area of the leg rest is reduced and to arrange or store the leg rest is convenient.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A foldable leg rest comprising:
a base including a mounting board and a first stage drive mechanism mounted on the mounting board;
a first folding assembly pivotally connected to the base, driven by the first stage drive mechanism and including:
a first frame having:
a front end; and
a rear end pivotally connected to the base; and
a second stage drive mechanism mounted in the first frame; and
a second folding assembly pivotally connected to the first folding assembly, being foldable toward a bottom surface of the first folding assembly, driven by the second stage drive mechanism and including a second frame having a rear end pivotally connected to the front end of the first frame.

2. The foldable leg rest as claimed in claim 1, wherein the first stage drive mechanism has
a first stage DC motor secured to the mounting board;
two gearings respectively disposed at two sides of the mounting board and each gearing having a mounting bracket secured to the mounting board and receiving:
a first stage worm driven by the first stage DC motor;
a first stage worm gear engaging the first stage worm;
a small gear coaxially mounted on the first stage worm gear;
a large gear engaging the small gear; and
a pivotal shaft coaxially mounted on the large gear; and
two first stage angle adjusters and each first stage angle adjuster mounted between one side of the rear end of the first frame and a corresponding mounting bracket and driven by a corresponding pivotal shaft.

3. The foldable leg rest as claimed in claim 2, wherein the second stage drive mechanism has
a second stage DC motor secured to the rear end of the first frame;
two worm drives respectively disposed at two sides of the first frame and each worm drive having:
a second stage first worm driven by the second stage DC motor;
a second stage first worm gear engaging the second stage first worm;
a second stage second worm coaxially mounted on the second stage first worm gear;
a second stage second worm gear engaging the second stage second worm;
a driving pulley coaxially mounted on the second stage second worm gear;
a driven pulley rotatably mounted on the front end of the first frame;
a belt mounted around the driving pulley and the driven pulley; and
a driving shaft coaxially mounted on the driven pulley; and
two second stage angle adjusters and each second stage angle adjuster mounted between one side of the rear end of the second frame and a corresponding side of the front end of the first frame and driven by a corresponding driving shaft.

4. The foldable leg rest as claimed in claim 3 further comprising a support stand pivotally connected between the first folding assembly and the second folding assembly.

5. The foldable leg rest as claimed in claim 4, wherein
the support stand includes two supporting rods and each supporting rod has
a top end; and
a cover formed on the top end of the supporting rod, pivotally connected to a corresponding connecting part of the first frame and the second frame, covering a corresponding driving shaft and having:
an internal surface; and
a pushed block protruding from the internal surface of the cover; and
the driving shaft of each worm drive has
an end; and
a pushing block secured around the driving shaft near the end, driven by the driving shaft and being able to abut the pushed block of a corresponding cover.

6. The foldable leg rest as claimed in claim 5, wherein
the cover of each supporting rod of the support stand further has
an open end surface; and
a recess formed in the open end surface of the cover and having two recess side surfaces, and
the driving shaft of each worm drive further has
a ring mounted around the driving shaft, not driven by the driving shaft and having:
an outer surface; and
a projection protruding from the outer surface of the ring and being able to abut one recess side surface of the recess of the corresponding cover.

7. The foldable leg rest as claimed in 1 further comprising a footrest pivotally connected to the second folding assembly.

8. The foldable leg rest as claimed in 2 further comprising a footrest pivotally connected to the second folding assembly.

9. The foldable leg rest as claimed in 3 further comprising a footrest pivotally connected to the second folding assembly.

10. The foldable leg rest as claimed in 4 further comprising a footrest pivotally connected to the second folding assembly.

11. The foldable leg rest as claimed in 5 further comprising a footrest pivotally connected to the second folding assembly.

12. The foldable leg rest as claimed in 6 further comprising a footrest pivotally connected to the second folding assembly.

13. The foldable leg rest as claimed in claim 7, wherein
the second folding assembly further includes a third stage drive mechanism mounted in the second frame and having:
a third stage DC motor secured to the rear end of the second frame;
two rear worm drives respectively disposed at two sides of the rear end of the second frame and each rear worm drive having:
a third stage rear worm driven by the third stage DC motor; and
a third stage rear worm gear engaging the third stage rear worm and connected to one of two ends of a third stage flexible shaft; and
two front worm drives respectively disposed at two sides of a front end of the second frame and each front worm drive having:
a third stage front worm connected to the other end of the third stage flexible shaft;
a third stage front worm gear engaging the third stage front worm;
a third stage gear coaxially mounted on the third stage front worm gear; and
a driving rod having an end and a gear formed on the end and engaging the third stage gear; and
the footrest includes two sides and two pivotal ears formed respectively on the sides and respectively secured to the driving rods disposed at the front end of the second frame.

14. The foldable leg rest as claimed in claim 8, wherein
the second folding assembly further includes a third stage drive mechanism mounted in the second frame and having:
a third stage DC motor secured to the rear end of the second frame;
two rear worm drives respectively disposed at two sides of the rear end of the second frame and each rear worm drive having:
a third stage rear worm driven by the third stage DC motor; and
a third stage rear worm gear engaging the third stage rear worm and connected to one of two ends of a third stage flexible shaft; and
two front worm drives respectively disposed at two sides of a front end of the second frame and each front worm drive having:
a third stage front worm connected to the other end of the third stage flexible shaft;
a third stage front worm gear engaging the third stage front worm;
a third stage gear coaxially mounted on the third stage front worm gear; and
a driving rod having an end and a gear formed on the end and engaging the third stage gear; and
the footrest includes two sides and two pivotal ears formed respectively on the sides and respectively secured to the driving rods disposed at the front end of the second frame.

15. The foldable leg rest as claimed in claim 9, wherein
the second folding assembly further includes a third stage drive mechanism mounted in the second frame and having:
a third stage DC motor secured to the rear end of the second frame;
two rear worm drives respectively disposed at two sides of the rear end of the second frame and each rear worm drive having:
a third stage rear worm driven by the third stage DC motor; and
a third stage rear worm gear engaging the third stage rear worm and connected to one of two ends of a third stage flexible shaft; and
two front worm drives respectively disposed at two sides of a front end of the second frame and each front worm drive having:
a third stage front worm connected to the other end of the third stage flexible shaft;
a third stage front worm gear engaging the third stage front worm;
a third stage gear coaxially mounted on the third stage front worm gear; and
a driving rod having an end and a gear formed on the end and engaging the third stage gear; and
the footrest includes two sides and two pivotal ears formed respectively on the sides and respectively secured to the driving rods disposed at the front end of the second frame.

16. The foldable leg rest as claimed in claim 10, wherein
the second folding assembly further includes a third stage drive mechanism mounted in the second frame and having:
a third stage DC motor secured to the rear end of the second frame;
two rear worm drives respectively disposed at two sides of the rear end of the second frame and each rear worm drive having:
a third stage rear worm driven by the third stage DC motor; and
a third stage rear worm gear engaging the third stage rear worm and connected to one of two ends of a third stage flexible shaft; and
two front worm drives respectively disposed at two sides of a front end of the second frame and each front worm drive having:
a third stage front worm connected to the other end of the third stage flexible shaft;
a third stage front worm gear engaging the third stage front worm;
a third stage gear coaxially mounted on the third stage front worm gear; and
a driving rod having an end and a gear formed on the end and engaging the third stage gear; and
the footrest includes two sides and two pivotal ears formed respectively on the sides and respectively secured to the driving rods disposed at the front end of the second frame.

17. The foldable leg rest as claimed in claim 11, wherein
the second folding assembly further includes a third stage drive mechanism mounted in the second frame and having:
a third stage DC motor secured to the rear end of the second frame;
two rear worm drives respectively disposed at two sides of the rear end of the second frame and each rear worm drive having:
a third stage rear worm driven by the third stage DC motor; and
a third stage rear worm gear engaging the third stage rear worm and connected to one of two ends of a third stage flexible shaft; and
two front worm drives respectively disposed at two sides of a front end of the second frame and each front worm drive having:
a third stage front worm connected to the other end of the third stage flexible shaft;
a third stage front worm gear engaging the third stage front worm;
a third stage gear coaxially mounted on the third stage front worm gear; and
a driving rod having an end and a gear formed on the end and engaging the third stage gear; and
the footrest includes two sides and two pivotal ears formed respectively on the sides and respectively secured to the driving rods disposed at the front end of the second frame.

18. The foldable leg rest as claimed in claim 2, wherein two first stage contact switches are respectively secured to a sidewall of one mounting bracket and a second abutting block is secured around one pivotal shaft and is contactable with one of the first stage contact switches.

19. The foldable leg rest as claimed in claim 3, wherein
two second stage contact switches are respectively mounted at the rear end of the first frame and are disposed at one side adjacent to one of the worm drives;
a threaded rod is coaxially mounted on the driving pulley adjacent to the second stage contact switches; and
a nut is screwed onto the threaded rod and is longitudinally movable thereon and the nut has
a contacting segment extending therefrom and being contactable with one of the second stage contact switches.

20. The foldable leg rest as claimed in claim 13, wherein
a third stage front contact switch is mounted on a bottom surface of the second frame adjacent to one of the front worm drives and a third stage rear contact switch is mounted on the bottom surface of the second frame adjacent to the third stage DC motor;
one of the pivotal ears of the footrest has a contacting block extending therefrom and being contactable with the third stage front contact switch; and
the footrest is foldable toward a bottom surface of the second folding assembly to contact the third stage rear contact switch.
